(19) United States
(12) Patent Application Publication
(10) Pub. No.: US 2004/0169037 A1
(43) Pub. Date: Sep. 2, 2004

(54) Water vapour generating device for heating foodstuffs in a microware oven

(76) Inventors: Edmond Roussel, Danvou La Ferriere (FR); Marc Henri Legrand, Caen (FR)

Correspondence Address: RANDALL J. KNUTH P.C., 3510-A STELLHORN ROAD, FORT WAYNE, IN, 46815-4631, US

(21) Appl. No.: 10/473,562

(22) PCT Filed: Mar. 22, 2002
(86) PCT No.: PCT/FR02/01008

(30) Foreign Application Priority Data
Mar. 27, 2001 (FR) 01/04086
Oct. 12, 2001 (FR) 01/13168

(51) Int. Cl. H05B 6/80

(52) U.S. Cl. 219/731

(57) ABSTRACT

A water vapor generating device is designed to be introduced in a container for heating or cooking food products with microwaves. The device includes a package or a bag made of a material that is at least partly porous or permeable to water vapor. The package contains a gel capable of rapidly absorbing the microwaves. The gel includes one part by weight of hydrocolloid corresponding to its dry form, per at least 10 parts by weight of water.

### BACKGROUND OF THE INVENTION

1. Field of the Invention

The present invention relates to a water vapor generating device, more particularly intended to be introduced into a packaging for heating or cooking foodstuffs, in particular with microwaves.

2. Description of the Related Art

Since they appeared on the market, microwave ovens have been bought in large numbers by consumers and they are now to be found in many households. Microwave ovens have the basic advantage that they allow foodstuffs to be cooked or reheated very quickly since the internal layers of the foodstuffs directly capture the electromagnetic energy radiated. Such energy is immediately available without the need for reaction time to increase the temperature of the oven.

However, controlling the thermal profile in an environment heated by microwaves is complex. There are interactions between the thermal fields and the electromagnetic fields with an influence owing to the oven housing, the product introduced therein, and the generator. Therefore, heating with microwaves has not, in practice, enabled a quality of cooking to be obtained which is comparable with that obtained in a conventional oven.

In an oven of conventional type, the increase in temperature results from phenomena of infrared radiation, conduction and convection. The thermal energy absorbed by the superficial layers of the food product to be heated diffuses towards the internal layers of the food product. These thermal transfers are generally slow (although they can be accelerated in liquids by the presence of convection currents). As such, the heating of the products is consequently slow but uniform.

On the other hand, heating with microwaves brings about, owing to the speed thereof, thermal heterogeneity resulting from a non-uniform distribution of the energy which is dissipated and absorbed in the heated product and which cannot be compensated for during heating by the diffusion of the heat.

This results in two significant disadvantages. The first of these disadvantages is linked to the fact that the heat source is constituted by the food product itself. Therefore, the heating of the product is greater in the internal layers than at the surface thereof, with the result that the central portion of the product is often too hot and dried out.

The second disadvantage is linked to the fact that the heterogeneous distribution of the electromagnetic waves leads to the presence of “hot” points and “cold” points, the distribution of which is very variable and is dependent both on the oven (size of the chamber, structure and positioning of the radiation element, etc.) and on the product to be heated (composition, temperature, shape, volume, packaging, position in the oven, etc.).

The instability of heating in a microwave oven also results from connection phenomena between the food product to be heated, the oven chamber and the generator. The power which is effectively absorbed by this product is dependent on the load represented by the assembly constituted by the product and the oven housing, which acts on the reflection of the waves towards the generator and on the power emitted by the generator. This load varies during heating and consequently the power absorbed by the product to be heated cannot be fixed during the total duration of the heating process.

Furthermore, the thermal characteristics of microwaves differ from conventional thermal characteristics. This difference is owed to the inversion of the thermal gradient in the mass of the heated product which brings about an inversion of the sense of migration of water. Since it is now the food product which heats the oven, it is always difficult to evaporate water. As a result the outer surface of this product still remains moist, while the internal portion of the product tends to dry out.

In order to overcome these disadvantages and to improve the quality and efficiency of heating with microwaves, specialists have already had the idea of attempting to transform a substantial portion of the radiated electromagnetic energy into thermal energy, without the speed of the process being impaired.

It is well known that moist foodstuffs are excellent convectors of energy owing to their high level of permittivity. However, owing to the vaporization of this water, the rapid transformation of electromagnetic energy into thermal energy at the center of a food product containing high levels of water very often leads to substantial modifications and to a change in the structure of the food product. In particular, a variation occurs which adversely affects the consistency of the food product.

In order to produce water vapor without changing the structure of food products to be heated, it has been proposed that additional water be introduced into the oven housing, in particular by a glass of water being placed therein. The water contained in the glass can absorb the electromagnetic waves emitted by the generator and transform them into vapor capable of transferring the energy received to the foodstuffs present in the oven. However, introducing water into the housing of a microwave oven in this manner is impossible when the food product must be heated directly in the packaging in which it is offered for sale by the industrial manufacturer.

Numerous foodstuffs are currently sold in individual packagings which are produced in particular at least partially from plastics films and which are intended to be placed directly in a microwave oven. The products packaged in this manner are bought in increasing numbers by consumers. In order to overcome this problem, it has already been proposed that foodstuffs be packaged in semi-rigid receptacles which are closed by a plastic film and which are provided with a double base which delimits a humidification chamber which communicates with the foodstuffs via perforations and which contains a pad soaked in water.

In spite of its obvious advantages, a packaging of this type has a given number of disadvantages linked, in particular, to the presence of the pad soaked in water, the result of which is:

it cannot correspond to a packaging which is produced entirely from a flexible plastics film but must necessarily be constituted by a semi-rigid receptacle,

the receptacle must be modified in order to allow the pad to be positioned (addition of a double base and positioning of the pad in the humidification chamber which is delimited by the base);

the pad must be placed in the receptacle during the production of the receptacle; and

the pad can absorb only a limited quantity of water.

The object of the present invention is to overcome these disadvantages by providing a water vapor generating device which can be introduced into packagings of any type at the same time as the foodstuffs to be packaged and which is capable, at the same time, of holding a very large quantity of water which can be released back in the form of water vapor by a simple heating operation.

### SUMMARY OF THE INVENTION

This device is characterized in that it is constituted by a packaging, in particular a sachet, which is produced from a material at least partially porous or pervious to water vapor and which contains a gel capable of rapidly absorbing the microwaves. This gel contains one part by weight of a hydrocolloid corresponding to the dry form thereof, per at least 10 parts by weight of water.

It is well known by specialists and is, in particular, mentioned in the “Dictionnaire de la chimie et de ses applications” (Dictionary of chemistry and its applications) by C and R DUVAL, that a gel is a viscoelastic mass formed from given colloidal suspensions. Within the scope of this description, a hydrocolloid is conventionally understood to be the dry form of a gel of this type. The hydrocolloid is therefore capable of retaining a large quantity of water in the form of a gel and releasing the water back in the form of vapor following the heating brought about, in particular, by microwaves. According to another feature of the invention, the viscosity of the gel is at least from to 2 to 3 10⁻¹ Pa.s.

It should be noted that the formation of the gel results from a physical reaction which allows the water to be retained at the center of a three-dimensional lattice formed by the hydrocolloid molecules. As a result, the water loses all freedom and is therefore held and, in a manner of speaking, “masked” by the three-dimensional lattice. This corresponds to a phenomenon which differs substantially from simple absorption by which the water soaks a pad similar to an absorbent paper and can be released back under the action of minimal pressure.

According to the invention, it is advantageous to select the concentration of hydrocolloid at the center of the gel so as to be as far away as possible from the saturation limit and to prevent salting-out in so far as possible, thus allowing the water retention capacity to be improved.

It should be noted that the device according to the invention, if specially adapted for heating or cooking in a microwave oven, can also be introduced into a packaging for heating foodstuffs by means of a thermal oven.

According to a first variant of the invention, the hydrocolloid can be selected from natural molecules such as alginates, carraghenanes and/or guar gum.

According to a second variant of the invention, the hydrocolloid can be selected from cellulose derivatives such as carboxymethyl cellulose or ethylcellulose.

According to a third variant of the invention, the hydrocolloid can be selected from the synthetic super-absorbents such as the polyacrylic acid salts which absorb at least 7 times more water per gram than absorbent papers and up to approximately at least 50 times their weight in water. The super-absorbent which can be used according to the invention corresponds to a cross-linked compound having a variable granulometry which can be in the range from one micrometer to several micrometers.

The water added to this hydrocolloid in order to allow the formation of the gel can, if necessary, be a spring water, in particular when a natural hydrocolloid is used, in particular when the quality of the water available at the premises where the food product is packaged is questionable and may be detrimental to consumer confidence.

Furthermore, if necessary and without exceeding the scope of the invention, this water can be supplemented by ingredients, such as perfumes, aromatic agents, and/or natural volatile extracts, which can have various effects on the flavor, the conservation (i.e., shelf-life) of the food product (bacteriostatic or fungistatic; essential oils or oleoresins), and/or on the health and the well-being of consumers.

Of course, the quantity of gel contained in the sachet is dependent in each case on the quantity of water vapor desired, and the desirable length of time for which the water vapor is produced.

According to the invention, the porosity of the sachet must be sufficient to allow the water vapor produced under the action of the microwaves to be rapidly discharged, without the risk of the sachet bursting. To this end, this porosity must as a general rule be greater than 1500 ml/minute measured using the Bendtsen porosity meter. Furthermore, it is necessary to ensure that the material forming the sachet withstands the temperature which results from the gel being heated under the action of the microwave radiation.

According to the invention, this material can, by way of example, be constituted by a non-woven material, in particular based on polyethylene or preferably polypropylene. In the case of a membrane of non-woven polypropylene or a non-hydrophilic membrane, this material can be processed by the addition of a surfactant substance approved for contact with foods, in particular from the series of silicone derivatives, by way of example polydimethylsiloxanes, in order to render the membrane hydrophilic and to accelerate the transfer of water.

According to the invention, it is advantageous for the device for generating water vapor to be able to reabsorb, after the vapor production phase, the condensates formed during cooling and also the exudates produced by the food product which has been processed in the microwave oven. To this end, it is of course necessary for the sachet not to be water-tight and not to have itself absorbent characteristics. In this case, it is appropriate to use as a hydrocolloid, preferably a super-absorbent such as the polyacrylic acid salts, of a quality suitable for contact with foods.

In order to optimize the reabsorption of the condensed water and exudates, it is possible, according to another feature of the invention, for the sachet to comprise an outer membrane of a hydrophilic material.

By way of example, the sachet can be produced from a paper which is laminated to a perforated film which is welded/adhered to itself, the paper being positioned outside the sachet.

According to a particularly advantageous feature of the invention, the sachet can also be produced from a complex which is welded/adhered to itself and which is constituted by an outer face of a perforated non-hydrophilic material and an inner face of a hydrophilic material constituted, in particular, by a non-woven material. This configuration has the advantage of allowing a sachet to be produced whose outer face is less susceptible to risks of contamination in contact with foods.

Moreover, the non-hydrophilic material can be translucent and printed on the inner face thereof in contact with the hydrophilic material.

By way of a first example, it has been found that a sachet measuring 120 mm×80 mm, which is formed from a paper of 30 g/m² laminated to a film of perforated polypropylene which is heat-sealed to itself, and which contains, on the one hand, 2 g of super-absorbent constituted by sodium polyacrylate and, on the other hand, 20 g of water can release approximately 5 liters of vapor per minute of exposure in a microwave oven (750 W) for 5 minutes. After having lost almost all of its water under the action of heating by microwaves, a sachet of this type is capable of reabsorbing up to 60 g of condensed water and exudates.

By way of a second example, it has been found that a sachet measuring 80 mm×80 mm which is formed, on the one hand, from two sheets associated by heat-sealing at the edges thereof. Of the two sheets sealed together, one sheet is a material which is impervious to water vapor covered by a layer of polypropylene which can be welded/adhered on the inner face thereof. The second is a sheet of a non-woven material of polypropylene of 75 g/m² which contains, on the other hand, 1.5 g of super-absorbent constituted by sodium polyacrylate. This combination of sheets can thus absorb, when in contact with water, at least 40 g of water in a few seconds via the sheet produced from polypropylene. This quantity of water can be released by heating, by way of example, with microwaves.

By way of a third example, it has been found that a sachet measuring 80 mm×80 mm which is produced, on the one hand, from a complex which is welded/adhered to itself and which is constituted by an outer face of perforated polyethylene laminated to an inner face of a non-woven material of polypropylene. On the other hand, the sachet contains 1.5 g of super-absorbent constituted by sodium polyacrylate. Such a sachet can thus absorb, when in contact with hot water, at least 40 g of water in a few tens of seconds. This quantity of water can be released by heating, by way of example, with microwaves.

By way of a fourth example, the retention capacity of a water vapor generating device according to the invention has been examined. To this end, sachets measuring 80 mm×80 mm were produced from a complex which is welded/adhered to itself and which is constituted by an outer face of perforated polyethylene terephthalate (PET) and by an inner face of a non-woven hydrophilic material of PET/polyethylene (PE). This non-woven hydrophilic material is itself constituted by short fibers, composed of two components (PET in the center and PE at the surface). These two components, in turn, are associated with each other by thermal bonding in order to form a web of 35 g per m². The perforated outer film of PET is printed on the face in contact with the non-woven material to which it is laminated.

It was found that the sachet leaks drop by drop with no constraint other than its own weight when 20 g of water were introduced into a sachet produced in this manner. A sachet of this type was further placed under a load of 1 kg and it was found that the sachet empties in a few seconds.

Then, 1.5 g of super-absorbent constituted by sodium polyacrylate were introduced into a similar sachet. It was found that a sachet of this type can absorb 40 g of hot water at 60° C. in 10 seconds and 60 g of hot water at 60° C. in 17 seconds. It was found that a sachet containing 60 g of water and 1.5 g of super-absorbent does not leak and remains completely dry. However, when the sachet is placed under a load of 1.15 kg, droplets of water form in the region of the perforations of the PET.

It was found at the same time that a sachet containing 40 g of water and 1.5 g of super-absorbent does not leak and remains completely dry even when placed under a load of 1.15 kg and loads of 1.9 kg and 3.8 kg. On the other hand, when the sachet is placed under a load of 5.3 kg, the sachet becomes moist. Further, when it is placed under a load of 20 kg, droplets of water form in the region of the perforations of the PET.

The invention also relates to a packaging for heating or cooking foodstuffs, in particular with microwaves, characterized in that it includes foodstuffs and a water vapor generating device of the above-mentioned type. Of course, this packaging can be of any type and can be constituted in particular by a receptacle of a rigid or semi-rigid material without thereby exceeding the scope of the invention. According to a particularly advantageous feature of the invention, such a packaging is, however, constituted by a film which is preferably thermoretractable.

According to another feature of the invention, the film is produced from a plastic material which is transparent to microwaves. When a packaging of this type produced from a thermoretractable film is introduced into a microwave oven, the electromagnetic radiation brings about a large increase in the pressure present therein. This increase results, on the one hand, from the production of water vapor and, on the other hand, from the reduction of the volume linked to the retraction of the film. This pressure increase results in an increase in the vapor temperature, and therefore the thermal efficiency of the vapor, thus allowing a type of “pressure-cooker” effect to be produced.

A valve or, for example, a cut-out means, can also be incorporated into the packaging, allowing the packaging to be prevented from bursting under an excessive pressure which is too high.

It should be noted that, in this case, the porosity of the sachet containing the gel can be reduced to some 10 to 50 ml per minute measured using the Bendtsen porosity meter. The reduction in the volume of the packaging containing the foodstuff brings about a rapid increase in the pressure within the packaging. This rapid pressure increase compensates for the internal pressure of the sachet and thus prevents the sachet from bursting.

It should be noted that this packaging according to the invention can be adapted for a wide range of applications, in particular for blanching, pre-cooking or cooking fruit or fresh vegetables, or cereals and pre-prepared meals, and for reheating frozen products, not only by means of a microwave oven but also by means of a thermal oven, etc.

Furthermore, it should be noted that the microwave ovens which are currently commercially available can have two different frequencies. The frequency of domestic microwave ovens is 2450 MHz, while the frequency of industrial microwave ovens is 915 MHz. These microwave ovens which are in particular used in the food industry for carrying out defrosting (tempering) operations have a significantly greater penetration. However, they cannot be used without specific authorization.

A further advantage of the invention is linked to the fact that it allows operations, such as defrosting large blocks of food products, to be carried out with conventional domestic ovens which could previously be carried out only with industrial ovens.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A water vapor generating device configured for introducing water vapor into a packaging for at least one of heating and cooking foodstuffs via microwaves, the water vapor generating device comprising:
a packaging produced from a material at least partially porous to water vapor; and
a gel contained in the packaging, said packaging being capable of rapidly absorbing the microwaves, the gel containing one part by weight of hydrocolloid corresponding to the dry form thereof per at least 10 parts by weight of water.

2. The water generating device according to claim 1, wherein the viscosity of the gel is at least from 2 to 3 10⁻¹ Pa.s.

3. The water generating device according to claim 1, wherein the hydrocolloid is selected from natural molecules.

4. The water generating device according to claim 1, wherein the hydrocolloid is selected from cellulose derivatives.

5. The water generating device according to claim 1, wherein the hydrocolloid is selected from a group of synthetic super-absorbents.

6. The water generating device according to claim 1, wherein the packaging is a sachet, the sachet being constituted of a non-woven material based on at least one of polyethylene and polypropylene.

7. The water generating device according to claim 1, wherein the packaging is a sachet, the sachet including an outer membrane of a hydrophilic material.

8. The water generating device according to claim 7, wherein the sachet is produced from a paper which is laminated to a perforated film which is adhered to itself, the paper being positioned outside the sachet.

9. The water generating device according to claim 1, wherein the packaging is a sachet, the sachet being produced from a complex which is adhered to itself and which is constituted of an outer face of a perforated non-hydrophilic material and an inner face of a hydrophilic material.

10. The water generating device according to claim 9, wherein the hydrophilic material for the inner face is constituted of a non-woven material.

11. The water generating device according to claim 1, wherein the water used to constitute the gel is a spring water.

12. The water generating device according to claim 1, wherein the water used to constitute the gel is supplemented by at least one ingredient chosen from a group consisting of perfumes, aromatic agents, and natural volatile extracts.

13. A food preparation system including a water vapor generating device according to claim 1, the food preparation system being configured for facilitating at least one of heating and cooking food with microwaves, the system further comprising:
a primary packaging; and
at least one foodstuff contained in the primary packaging.

14. The food preparation system according to claim 13, wherein the primary packaging is constituted by a film which is thermoretractable.

15. Packaging according to claim 14, wherein the film is composed of a plastic material which is transparent to microwaves.

16. The water generating device according to claim 3, wherein the hydrocolloid is selected from a group consisting of alginates, carraghenanes and guar gum.

17. The water generating device according to claim 4, wherein the hydrocolloid is selected from a group consisting of one of carboxymethyl cellulose or ethylcellulose.

18. The water generating device according to claim 5, wherein the hydrocolloid is selected from a group consisting of polyacrylic acid salts.
